(19) United States
(12) Patent Application Publication
(10) Pub. No.: US 2021/0391566 A1
(43) Pub. Date: Dec. 16, 2021

(54) PROCESS FOR CONTROLING SILICON CARBIDE FIBER FORMATION IN BATTERY SECONDARY PARTICLES

(71) Applicant: Nanostar, Inc., New Orleans, LA (US)

(72) Inventors: Jonathan Goodman, New Orleans, LA (US); Byoung Chul You, Metairie, LA (US); Shiva Adireddy, Metairie, LA (US); Meysam Shahami, New Orleans, LA (US)

(21) Appl. No.: 17/349,236

(22) Filed: Jun. 16, 2021

Related U.S. Application Data
(60) Provisional application No. 63/039,621, filed on Jun. 16, 2020.

(51) Int. Cl. H01M 4/36; H01M 10/0525; H01M 4/58; H01M 4/38

(52) U.S. Cl. CPC H01M 4/364; H01M 10/0525; H01M 2004/027; H01M 4/386; H01M 4/58

(57) ABSTRACT

A process for the controlled synthesis of silicon carbide reinforced secondary particles is provided. The process includes forming an microaggregate from an admixing a plurality of silicon nanoparticles, a plurality of silicon oxide nanoparticles, a carbon source, and a fiber-catalyst and then thermalizing the microaggregate and forming silicon carbide nanofibers throughout a resulting spherical microcomposite (silicon carbide reinforced secondary particle).

### CROSS-REFERENCE TO RELATED APPLICATION

This application claims the benefit of U.S. Provisional Application Ser. No. 63/039,621 filed on Jun. 16, 2020, the contents of which are incorporated herein in its entirely by reference.

### FIELD OF THE INVENTION

The present invention is directed to the methods of forming silicon carbide comprising secondary particles for use in lithium ion batteries.

### BACKGROUND

Lithium-ion (Li⁺) secondary or rechargeable batteries are now the most widely used secondary battery systems for portable electronic devices. However, the growth in power and energy densities for lithium ion battery technology has stagnated in recent years as materials that exhibit both high capacities and safe, stable cycling have been slow to be developed. Much of the current research effort for the next generation of higher energy capacity materials has revolved around using small or nanoparticulate active material bound together with conductive agents and carbonaceous binders.

The current state-of-the-art for anode electrodes in lithium ion batteries includes the use of high surface area carbon materials. However, the capacity of any graphitic carbon, carbon black, or other carbonaceous material is limited to a theoretical maximum of 372 mAh/g and about 300 mAh/g in practice because carbon electrodes are usually formed of carbon particles mixed with a polymeric binder pressed together to form a bulk electrode. To store charge, Li⁺ intercalates between the planes of sp² carbon atoms and this C—Li⁺—C moiety is reduced. In addition, the maximum number of Li⁺ that can be stored is one per every six carbon atoms (LiC₆). While the capacity of graphitic carbon is not terribly high, the intercalation process preserves the crystal structure of the graphitic carbon, and so cycle life can be very good.

A more recent and promising option for anode materials is silicon (Si). In contrast to the intercalative charge storage observed in graphite, Si forms an alloy with lithium. Silicon-based negative electrodes are attractive because their high theoretical specific capacity of about 4200 mAh/g, which far exceeds than that of carbon, and is second only to pure Li metal. This high capacity comes from the conversion of the Si electrode to a lithium silicide which at its maximum capacity has a formula of Li₂₂Si₆, storing over 25 times more Li per atom than carbon. The large influx of atoms upon alloying, however, causes volumetric expansion of the Si electrode of over 400%. This expansion causes strain in the electrode, and this strain is released by formation of fractures and eventual electrode failure. Repeated cycling between LiₓSi_{y} and Si thus causes crumbling of the electrode and loss of interconnectivity of the material. For example, 1 μm thick Si film anodes have displayed short cyclability windows, with a precipitously capacity drop after only 20 cycles.

Still more recently, silicon carbide (SiC) has been tested in anodic laminates that include silicon metal (Si). Some observations suggest that during prolonged cycling the SiC degrades to silicon metal and a carbon product, thereby increasing or maintaining the observed energy density. Accordingly, new anode materials that include silicon carbide and methods for their manufacture are necessary for further improvements in lithium-ion batteries.

### SUMMARY

A first embodiment is a process that includes admixing a plurality of silicon nanoparticles, a plurality of silicon oxide nanoparticles, a carbon source, and a fiber-catalyst; the admixture including a molar ratio of silicon nanoparticles to silicon oxide nanoparticles in the range of about 25:1 to about 1:1; forming an microaggregate from the admixture; and then thermalizing the microaggregate at a temperature of about 900 to about 1500° C. thereby forming silicon carbide nanofibers throughout a spherical microcomposite; the microcomposite having an average diameter of about 2 microns to about 25 microns.

A second embodiment is a process that includes providing a silicon suboxide nanopowder by co-milling silicon metal and silicon dioxide; where the silicon suboxide nanopowder has a composition of SiOx where x is between 0.01 to about 1; forming an microaggregate from the silicon suboxide nanopowder, a carbon source, and a fiber-catalyst; and then thermalizing the microaggregate at a temperature of about 900 to about 1500° C. thereby forming silicon carbide nanofibers throughout a spherical microcomposite; the microcomposite having an average diameter of about 2 microns to about 25 microns.

### DETAILED DESCRIPTION

Objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

Herein, the use of the word “a” or “an” when used in conjunction with the term “comprising” in the claims and/or the specification may mean “one,” but it is also consistent with the meaning of “one or more,” “at least one,” and “one or more than one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

A first embodiment of the invention described herein is a process for the production of microcomposites, sometimes called secondary particles, useful in lithium-ion batteries. Specifically, silicon and/or silicon carbide comprising microcomposites that are useful in anodic laminates. The process includes the formation and then thermolysis of a microaggregate where the process produces silicon carbide nanofibers within/throughout the resulting microcomposite. Herein, the microcomposites and microaggregates are differentiated based on their composition, wherein the microcomposites are result of thermalizing, pyrolyzing, or otherwise heating the microaggregates. In a preferable instance, the microcomposites further differ from the microaggregates compositionally as the microcomposites include silicon carbide.

A first step in the process can include admixing a plurality of silicon nanoparticles, a plurality of silicon oxide nanoparticles, a carbon source, and a fiber-catalyst; the admixture including a molar ratio of silicon nanoparticles to silicon oxide nanoparticles in the range of about 25:1 to about 1:1. The process can then include forming an microaggregate from the admixture, and thereafter thermalizing the microaggregate at a temperature of about 900 to about 1500° C. In one instance, the microaggregate is formed by spray drying; in another instance, the microaggregate is formed by granulation. Preferably, the resulting the microcomposite has an average diameter of about 2 microns to about 25 microns, more preferably about 5 microns to about 20 microns, about 5 microns to about 15 microns, or about 5 microns to about 10 microns.

Varying the molar ratio of the silicon nanoparticle to silicon oxide nanoparticles can affect that yield, quality, and distribution of the silicon carbide nanofibers. Herewith, the molar ratio of silicon nanoparticles to silicon oxide nanoparticles can be in the range of about 25:1 to about 1:1, about 20:1 to about 1:1, about 15:1 to about 2:1, about 10:1 to about 2:1, or about 10:1 to about 4:1. Alternatively the molar ratio of silicon nanoparticles to silicon oxide nanoparticles can be about 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or 1:1. More preferably, the silicon nanoparticles are always in excess to the silicon oxide nanoparticles both on a molar and a mass basis. Even more preferably, the atomic ratio of silicon to oxygen based on the silicon nanoparticles and silicon oxide nanoparticles is always greater than 1, still more preferably the atomic ratio is greater than 2, 3, 4, 5, 6, 7, 8, 9, 10, 15, 20, or 25. Notably, the atomic ratio includes any native oxide formed on the silicon nanoparticles, and can be determined by an elemental analysis of the silicon nanoparticles and silicon oxide nanoparticles either individually or as an admixture.

In a preferable example, the silicon nanoparticles and the silicon oxide nanoparticles each have average diameters in the range of about 50 nm to about 450 nm. More preferably, the silicon nanoparticles and the silicon oxide nanoparticles individually have average diameters in the range of about 75 nm to about 300 nm, or about 100 nm to about 300 nm. In another example, the silicon nanoparticles can have an average diameter that is greater than the silicon oxide nanoparticles average diameter. In one instance, the silicon nanoparticles have an average diameter of about 150 nm, 200 nm, 250 nm, 300 nm, 350 nm, 400 nm, or ranges therein; while the silicon oxide nanoparticles have an average diameter that is smaller than the silicon nanoparticle average diameter and is about 10 nm, 15 nm, 20 nm, 25 nm, 30 nm, 35 nm, 40 nm, 45 nm, 50 nm, 75 nm, 100 nm, 125 nm, 150 nm, 200 nm, 250 nm, or ranges therein.

The silicon nanoparticles preferably include about 70 wt. %, 75 wt. %, 80 wt. %, 85 wt. %, 90 wt. %, about 95 wt. %, about 98 wt. %, about 99 wt. %, about 99.5 wt. %, or about 99.9 wt. % silicon (silicon metal). In one instance, the silicon nanoparticles consist essentially of silicon metal. In another instance, the silicon nanoparticles consist of silicon metal. In another example, the silicon nanoparticles include n-doped or p-doped silicon metal.

In yet another example, the silicon nanoparticles include a silicon alloy (a silicon metal alloy). The silicon alloy can be a binary alloy (silicon plus one alloying element), can be a tertiary alloy, or can include a plurality of alloying elements. The silicon alloy is understood to include a majority silicon. A majority silicon means that the nanoparticles have a weight percentage that is greater than about 50% (50 wt. %) silicon, preferably greater than about 60 wt. %, 70 wt. %, 80 wt. %, 90 wt. %, 95 wt. %, 96 wt. %, 97 wt. %, 98 wt. %, 99 wt. %, or 99.5 wt. % silicon. The alloying element can be, for example, an alkali metal, an alkaline-earth metal, a Group 13 to 16 element, a transition metal group element, a rare earth group element, or a combination thereof, but, obviously, not Si. The alloying element can be, for exmaple, Li, Na, Mg, Ca, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, B, Al, Ga, In, Ge, Sn, P, As, Sb, Bi, S, Se, Te, or a combination thereof. In one instance, the alloying element can be lithium, magnesium, aluminum, titanium, vanadium, chromium, manganese, iron, cobalt, nickel, copper, or a mixture thereof. In another instance, the alloying element can be selected from copper, silver, gold, or a mixture thereof. In still another instance, the silicon alloy can be selected from a SiTiNi alloy, a SiAlMn alloy, a SiAlFe alloy, a SiFeCu alloy, a SiCuMn alloy, a SiMgAl alloy, a SiMgCu alloy, or a combination thereof.

As the term alloy typically infers a homogeneous distribution of the alloying element(s) in the base material, silicon (silicon metal), the silicon nanoparticles can further include a heterogeneous distribution of alloying elements in the nanoparticles. In some instances, these alloy elements form intermetallics in the silicon nanoparticles. An intermetallic (also called an intermetallic compound, intermetallic alloy, ordered intermetallic alloy, and a long-range-ordered alloy) is an alloy that forms a solid-state compound exhibiting defined stoichiometry and ordered crystal structure; here, within the silicon nanoparticle composition (e.g., a NiSi intermetallic within Si).

The silicon nanoparticles can be provided by milling a silicon feed to yield silicon nanocrystals. In one instance, the silicon feed is selected from recycled silicon metal, preferably industrial recycled silicon metal, for example from the photovoltaic or electronics industries. One particularly preferable source of silicon feed is silicon kerf from the sawing or cutting of silicon platters. Preferably, the silicon feed is milled in a comminution unit adapted to triturate solids to about the average particle diameter. That is, the silicon feed is milled to reduce the average diameter (particle size) of the material to a predetermined average particle diameter. Notably, the predetermination of the average particle diameter is mill dependent and can include the size of the milling media and/or the size of screens within a milling volume. The milling unit can be a comminution mill, a trituration mill, or another mill generally designed and adapted to reduce the size of a feed material by impact, grinding, shear, or other mechanical processes. The silicon feed is preferably milled in a solvent (e.g., a feed solvent). The feed solvent can include alkanes, alcohols, aromatics, or mixtures thereof, preferably the feed solvent is aprotic. Alkanes can be selected from butane, pentane, hexane, heptane, octane, nonane, decane, and mixtures thereof. Alcohols can be selected from methanol, ethanol, propanol, butanol, pentanol, hexanol, heptanol, octanol, nonanol, decanol, isomers thereof, and mixtures thereof. Aromatics can be selected from benzene, toluene, xylene, mesitylene, phenol, benxyl aochol, and mixtures thereof. The feed solvent can further include or can consists of acetone, methyl ethylketone, THF, DMF, DMSO, acetonitrile, benzonitrile, and mixtures thereof.

The silicon oxide nanoparticles can be silicon suboxide (SiOn where n is less than 2) or silicon dioxide (SiO₂), preferably the silicon oxide nanoparticles are silicon dioxide nanoparticles. In a preferable instance, the silicon oxide nanoparticles comprise about 95 wt. %, 96 wt. %, 97 wt. %, 98 wt. %, 99 wt. %, or 99.5 wt. % silicon dioxide. In another preferable instance, the silicon oxide nanoparticles consist essentially of silicon dioxide. In still another preferable instance, the silicon oxide nanoparticles consist of silicon dioxide.

The silicon oxide nanoparticles can be provided my milling a silicon oxide feed to yield silicon oxide nanocrystals. In one instance, the silicon oxide feed is selected from quartz, fused silica, fumed silica, microporous silica, or mixtures thereof. Preferably, the silicon oxide feed is milled in a comminution unit adapted to triturate solids to about the average particle diameter. That is, the silicon oxide feed is milled to reduce the average diameter (particle size) of the material to a predetermined average particle diameter. Notably, the predetermination of the average particle diameter is mill dependent and can include the size of the milling media and/or the size of screens within a milling volume. The milling unit can be a comminution mill, a trituration mill, or another mill generally designed and adapted to reduce the size of a feed material by impact, grinding, shear, or other mechanical processes. The silicon oxide feed is preferably milled in a solvent (e.g., a feed solvent). The feed solvent can include alkanes, alcohols, aromatics, or mixtures thereof, preferably the feed solvent is aprotic. Alkanes can be selected from butane, pentane, hexane, heptane, octane, nonane, decane, and mixtures thereof. Alcohols can be selected from methanol, ethanol, propanol, butanol, pentanol, hexanol, heptanol, octanol, nonanol, decanol, isomers thereof, and mixtures thereof. Aromatics can be selected from benzene, toluene, xylene, mesitylene, phenol, benxyl aochol, and mixtures thereof. The feed solvent can further include or can consists of acetone, methyl ethylketone, THF, DMF, DMSO, acetonitrile, benzonitrile, and mixtures thereof.

The thermolysis of the microaggregate is preferably carried out under an inert or a reducing atmosphere. Herein, an inert atmosphere is understood to mean an atmosphere that is free of or substantially free of oxygen and water. Typical inert atmospheres include nitrogen, argon, helium, or mixtures thereof. In one example, the microaggregate is thermalized under a hydrogen atmosphere (e.g., 5 vol. % H₂/N₂). In another example, the microaggregate is thermalized under a CO atmosphere and/or a CO₂ atmosphere. In one instance, the gas concentrations can be about 5, 10, 15, 20, 25, 30, 35, 40, 45, 50, 55, 60, 65, 70, 75, 80, 85, 90, 95, or 100 vol % CO in nitrogen or argon. In another instance, the gas concentrations can be about 5, 10, 15, 20, 25, 30, 35, 40, 45, 50, 55, 60, 65, 70, 75, 80, 85, 90, 95, or 100 vol % CO₂ in nitrogen or argon. In still another instance, the gas concentrations can be about 5, 10, 15, 20, 25, 30, 35, 40, 45, 50, 55, 60, 65, 70, 75, 80, 85, 90, 95, or 100 vol % CO/CO₂ in nitrogen or argon, where the ratio of CO to CO₂ is in the range of about 10:1 to about 1:10, about 5:1 to about 1:5, or about 2:1 to about 1:2.

The fiber-catalyst is preferably a first-row transition metal salt, for example, a manganese salt, an iron salt, a cobalt salt, a nickel salt, a copper salt, or a mixture thereof. In one preferable instance, the fiber-catalyst includes a nickel salt, more preferably consists of a nickel salt. The nickel salt can be a nickel acetate, a nickel nitrate, a nickel chlorate, a nickel oxalate, a nickel hydroxide, nickel sulfate, nickel formate, nickel citrate, or mixtures thereof. Preferably, the nickel salt thermally decomposes to a nickel or nickel oxide active catalysts for a vapor-liquid-solid or vapor-solid SiC nanofiber growth mechanism. In another instance, the fiber-catalyst includes an iron salt. In still another instance, the fiber-catalyst include a copper salt. In yet another instance, the fiber-catalyst includes an admixture of first row transitional metal salts, which in one example includes iron, and in another example includes copper. Preferably, the admixture includes nickel.

The carbon source can include a polymer selected from those that thermally decompose to provide inorganic carbon products (e.g., residue, char, amorphous carbon, etc). The polymer can be selected from a pitch, a phenolic resin, a polyacrylonitrile, an epoxy resin, a poly(furfuryl alcohol), and a mixture thereof. Preferably, the polymer is selected from a pitch, a phenolic resin, or a mixture thereof.

The carbon source can include or can further include (e.g., with the polymer) an inorganic carbon selected from an acetylene black, a ketjen black, a natural graphite, an artificial graphite, a carbon black, a carbon fiber, a multiwalled carbon nanotubes, a graphene, a graphene oxide, and a mixture thereof. The inorganic carbon, preferably, has an average maximum diameter or length of about 450 nm, preferably about 300 nm. That is, the inorganic carbon has an average size whether an average diameter (for particles) or an average length (for fibers) that is less than about 450 nm, preferably less than about 400 nm, 350 nm, 300 nm, 250 nm, or 200 nm. More preferably, the inorganic carbon has an average size that is on the order of the silicon nanoparticle average diameter.

The process can further include dispersing the fiber-catalyst on or in the carbon source. In one instance, the fiber-catalyst can be dispersed on or in the carbon source by admixing a slurry or solution of the fiber-catalysts and the carbon source and then drying the admixture. The dispersed fiber-catalyst on or in the carbon source can then be admixed with the silicon nanoparticles and the silicon oxide nanoparticles and the microaggregate formed.

Another embodiment is a process that includes providing a silicon suboxide nanopowder by co-milling silicon metal or a silicon alloy with silicon dioxide, then forming a microaggregate, before thermalizing the microaggregate to provide a microcomposite. Herein, the silicon suboxide nanopowder, preferably, has a composition/compositional formula that can be expressed as SiOₓ where x is between 0.01 to about 1. In one instance, x can be between about 0.01 and about 0.1; alternatively, x can be between about 0.5 and about 1. In the first instance, the process provides a microcomposite that includes silicon nanoparticles and silicon carbide nanofiber; whereas in the alternative instance the process provides a microcomposite that includes mostly silicon carbide nanofiber (i.e., greater than 50 atom % of the silicon is incorporated as silicon carbide; preferably greater than 60 atom %, 70 atom %, 80 atom %, 90 atom %, or 95 atom % of the silicon is incorporated into the microcomposite as silicon carbide; in one instance the microcomposite is substantially free of silicon metal). In a preferable instance, the process provides a microcomposite the is substantially free of silicon oxide, that is, all the silicon oxide is consumed (i.e., turned into silicon carbide) or lost during the thermalizing of the microaggregate.

The silicon suboxide nanopowder includes particulates which, preferably, have an average diameter of about 50 nm to about 500 nm. In one instance, the silicon suboxide nanopowder includes particulates which have an average diameter of about 75 nm to about 400 nm, about 100 nm to about 350 nm, about 100 nm to about 300 nm, about 100 nm to about 250 nm, or about 100 nm to about 200 nm.

Preferably, the silicon suboxide nanopowder is prepared/provided by co-milling a silicon metal or silicon alloy with a silicon dioxide. In a preferable instance, the co-milling is carried out in a non-protic solvent. Examples of non-protic solvents include pentane, hexane, heptane, octane, nonane, decane, benzene, toluene, xylene, mesytlene, THF, diethylether, ethylbutylether, dibutyl ether, acetone, acetonitrile, and mixtures thereof. Preferable non-protic solvents include hexane, benzene, toluene, THF, and mixtures thereof. Herewith, the co-milling can be carried out in by, for example, high energy ball milling, bead milling, or other comminution techniques known in the mining and metallurgical arts. Preferably, the co-milling comminutes the silicon metal and/or the silicon dioxide which interact through mechanochemical processes to provide the silicon suboxide nanopowder. Accordingly, the co-milling if preferably carried out in a solvent that does not interfere with the mechanochemical process between the silicon metal and the silicon dioxide, i.e. aprotic solvents.

In another instance, the silicon metal and the silicon dioxide can be comminuted under inert conditions (e.g., water and oxygen free) to predetermined average diameters and then admixed. Thereby the unsubstituted silicon metal surfaces can react with and bind to the silicon dioxide surfaces, affording the silicon suboxide nanoparticles.

Notably and in a preferable instance, the silicon suboxide nanoparticles include silicon nanoparticles having an average diameter of about 100 nm to about 300 nm carrying upon the surfaces thereof silicon dioxide nanoparticles having an average diameter of about 5 nm to about 50 nm. In one instance, the silicon suboxide nanoparticles can be silicon nanoparticles coated or carrying a plurality of silicon dioxide nanoparticles.

Herewith, the process further includes forming an microaggregate from the silicon suboxide nanopowder, a carbon source, and a fiber-catalyst. In one instance, the silicon suboxide nanopowder, the carbon source and the fiber-catalyst are admixed and thereafter formed into the microaggregate by a particulate forming technology, including but not limited to spray drying, spheroidization, and/or granulation. The microaggregate is then thermalized by heating to a temperature of about 900 to about 1500° C., preferably under an inert or reducing atmosphere. There thermalization of the microaggregate forms silicon carbide nanofibers throughout the resulting spherical microcomposite. The microcomposite preferably has an average diameter of about 2 microns to about 25 microns.

While the compositions and methods of this invention have been described in terms of preferred embodiments, it will be apparent to those of skill in the art that variations may be applied to the compositions and/or methods in the steps or in the sequence of steps of the method described herein without departing from the concept, spirit and scope of the invention. More specifically, it will be apparent that certain agents that are both chemically and physically related may be substituted for the agents described herein while the same or similar results would be achieved. All such similar substitutes and modifications apparent to those skilled in the art are deemed to be within the spirit, scope and concept of the invention as defined by the appended claims.

What is claimed:

1. A process comprising:
admixing a plurality of silicon nanoparticles, a plurality of silicon oxide nanoparticles, a carbon source, and a fiber-catalyst; the admixture including a molar ratio of silicon nanoparticles to silicon oxide nanoparticles in the range of about 25:1 to about 1:1;
forming an microaggregate from the admixture; and then
thermalizing the microaggregate at a temperature of about 900 to about 1500° C. thereby forming silicon carbide nanofibers throughout a spherical microcomposite; the microcomposite having an average diameter of about 2 microns to about 25 microns.

2. The process of claim 1, wherein the microaggregate is thermalized under a hydrogen atmosphere.

3. The process of claim 1, wherein the microaggregate is thermalized under a CO atmosphere.

4. The process of claim 1, wherein the microaggregate is thermalized under a CO2 atmosphere.

5. The process of claim 1, wherein the fiber-catalyst is a nickel salt.

6. The process of claim 1, wherein the carbon source includes a polymer selected from a pitch, a phenolic resin, a polyacrylonitrile, an epoxy resin, a poly(furfuryl alcohol), and a mixture thereof.

7. The process of claim 6, wherein the carbon source further includes an inorganic carbon selected from an acetylene black, a ketjen black, a natural graphite, an artificial graphite, a carbon black, a carbon fiber, a multiwalled carbon nanotubes, a graphene, a graphene oxide, and a mixture thereof; wherein the inorganic carbon has a maximum diameter or length of about 450 nm, preferably about 300 nm.

8. The process of claim 1, wherein the carbon source includes an inorganic carbon selected from an acetylene black, a ketjen black, a natural graphite, an artificial graphite, a carbon black, a carbon fiber, a multiwalled carbon nanotubes, a graphene, a graphene oxide, and a mixture thereof; wherein the inorganic carbon has a maximum diameter or length of about 450 nm, preferably about 300 nm.

9. The process of claim 1, wherein the fiber-catalyst is dispersed on or in the carbon source prior to forming the microaggregate.

10. The process of claim 1, wherein the silicon nanoparticles and the silicon oxide nanoparticles each have average diameters in the range of about 50 nm to about 450 nm.

11. The process of claim 1, wherein the silicon nanoparticles consist essentially of silicon metal.

12. The process of claim 1, wherein the silicon oxide nanoparticles consist essentially of silicon dioxide.

13. The process of claim 1, wherein the microaggregate is formed by spray drying.

14. The process of claim 1, wherein the microaggregate is formed by granulation.

15. A process comprising:
providing a silicon suboxide nanopowder by co-milling silicon metal or a silicon alloy with silicon dioxide; where the silicon suboxide nanopowder has a composition of SiOx where x is between 0.01 to about 1;
forming an microaggregate from the silicon suboxide nanopowder, a carbon source, and a fiber-catalyst; and then
thermalizing the microaggregate at a temperature of about 900 to about 1500° C. thereby forming silicon carbide nanofibers throughout a spherical microcomposite; the microcomposite having an average diameter of about 2 microns to about 25 microns.

16. The process of claim 15, wherein the microcomposite is substantially free of silicon oxide.

17. The process of claim 15, wherein the silicon suboxide nanopowder includes particulates having an average diameter of about 50 nm to about 500 nm.

18. The process of claim 15, wherein x is between about 0.01 and about 0.1.

19. The process of claim 15, wherein x is between about 0.5 and about 1.

20. The process of claim 15, wherein the silicon metal and the silicon dioxide are co-milled in a non-protic solvent.
